(19) United States
(12) Patent Application Publication
(10) Pub. No.: US 2008/0265592 A1
(43) Pub. Date: Oct. 30, 2008

(54) ANIMAL WASTE COLLECTION DEVICE WITH INTEGRATED BAG DISPENSER

(75) Inventor: Barry Askinasi, Mt. Sinai, NY (US)

Correspondence Address: DARBY & DARBY P.C., P.O. BOX 770, Church Street Station, New York, NY, 10008-0770, US

(73) Assignee: Four Paws Products, Ltd., Hauppauge, NY (US)

(21) Appl. No.: 11/740,083

(22) Filed: Apr. 25, 2007

(51) Int. Cl. A01K 29/00

(52) U.S. Cl. 294/1.4

(57) ABSTRACT

A litter and refuse retrieval device is provided for sanitarily cleaning up after a pet. The device includes two scoop elements which can be opened an closed and used for retrieving refuse. A storage compartment is incorporated into one of the scoops that may store and dispense items such as plastic bags. In operation, the user retrieves refuse by opening and closing the scoop elements. A plastic bag can be removed from the storage compartment and used to dispose of the retrieved refuse.

### FIELD OF THE INVENTION

The present invention relates to a refuse retrieval device. In particular, the present invention relates to a refuse retrieval device having a storage compartment.

### BACKGROUND OF THE INVENTION

Pet refuse left on a sidewalk or on a street causes sanitary problems, particularly in large urban areas. Many cities have enacted local ordinances requiring that the pet owner clean up after their pets. Many people utilize plastic bags to cleanly dispose of the fecal matter. However, such a task is not only unpleasant to perform but may be difficult to perform at the same time as holding a dog by a leash. This task is further complicated if there is no convenient means for storing and accessing the plastic bags to be used for disposing of the waste. Therefore, there is a need to provide a device for cleaning up after a pet in a sanitary fashion that has the ability to store and dispense plastic bags and is also easily assembled and packaged.

U.S. Pat. No. 4,248,468 to Hastings discloses a litter and refuse retrieval device. The Hastings patent discloses a litter retrieval apparatus formed of an elongated unitary plastic frame having a handle section at one end, scoop-supporting arms at the other end, and an elongated central section having a passageway for receiving a control rod. The control rod extends through the passageway from the handle to the scoops. Linkages connect the lower end of the control rod to the scoops and spring biasing means are provided for biasing the scoops in a closed position. While most of the device can be cheaply made of molded plastic, the patent discloses that the control rod is made of metal, therefore increasing the cost of such a device. Since the control rod is narrow and extends down the length of the handle, it appears that it must be made of metal or another very strong material. Further, the apparatus fails to include a means for storing and dispensing items such as plastic bags.

U.S. Pat. No. 5,503,442 to Lee discloses a jaw type scooper with a casing for holding a roll of plastic bags. The casing is support between the shaft and the scooper assembly of the device The bags can be pulled out of the casing and passed through a slit in the scoop assembly to the interior of the assembly and then hung on the scoop assembly in an open position for picking up feces. However, the apparatus uses a separate case for holding the plastic bags which is supported between the shaft and the scoop assembly of the apparatus. Thus, the use of a separate case increase costs associated with manufacturing and assembly of the device.

The present invention provides an apparatus for retrieving refuse that incorporates a storage compartment in at least one of the scoops of the device that is suitable for storing plastic bags.

### SUMMARY OF THE INVENTION

A litter and refuse retrieval device is provided for sanitarily cleaning up animal refuse. The device includes two scoop elements which can be opened and closed for retrieving refuse. A storage compartment is incorporated into at least one of the scoops. The storage compartment is capable of storing items such as plastic bags.

A cover which can be selectively opened and closed is provided for permitting access to the storage compartment so that plastic bags may be placed therein. The cover has a hole so that the plastic bags may be accessed and dispensed from the storage compartment while the cover is closed. The plastic bags may be dispensed individually through the cover hole. A user may remove a plastic bag from the storage compartment through the cover hole and the refuse retrieved into scoop elements may be disposed of into the plastic bag.

### BRIEF DESCRIPTION OF THE DRAWINGS

FIG. 1 is a perspective view of the litter retrieval device of the present invention in a closed position;

FIG. 2 is a front elevational view thereof;

FIG. 3 is a right side elevational view thereof;

FIG. 4 is a top plan view thereof;

FIG. 5A is a partial sectional view of the scoop portion taken along line 5-5 of FIG. 2;

FIG. 5B is an enlarged view of the open storage compartment with exemplary plastic bags, taken from the view of FIG. 5A;

FIG. 6 is a partial frontal view of the latch for the storage compartment cover, taken along line 6-6 of FIG. 5A;

FIG. 7 is a partial frontal view of the hinge for the storage compartment cover, taken along line 7-7 of FIG. 5A;

FIG. 8A is a partial perspective view of another embodiment of the litter retrieval device of the present invention;

FIG. 8B is a partial perspective view thereof with a exemplary plastic bag;

FIG. 9A is a breakaway side view thereof with the scoops in an open position; and

FIG. 9B is a breakaway side view thereof with the scoops in an closed position.

### DETAILED DESCRIPTION OF PREFERRED EMBODIMENT

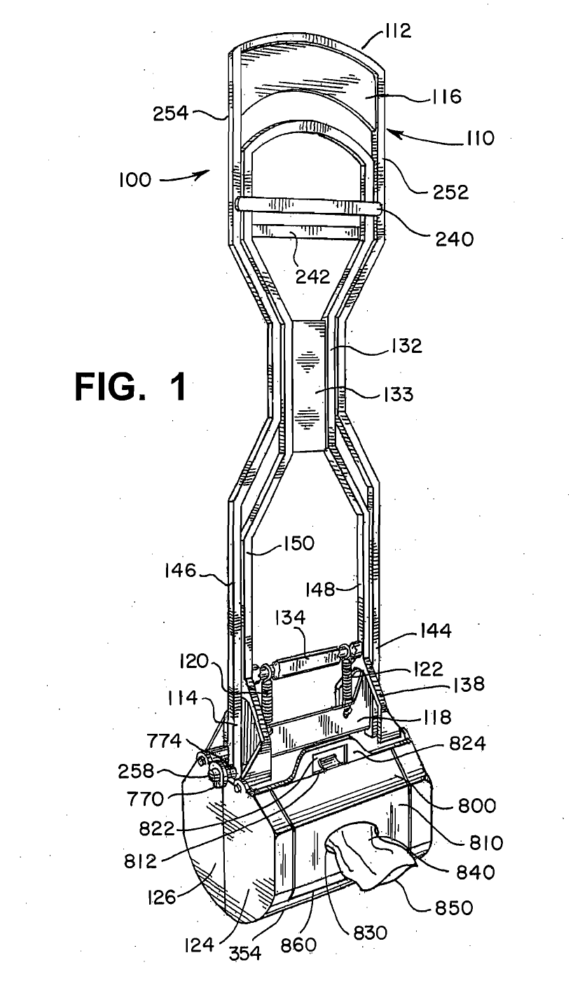

FIG. 1 is a perspective view of a preferred embodiment of the present invention. Referring to FIGS. 1-4, a litter and refuse retrieval device 100, which is similar to the type disclosed in U.S. Pat. No. 5,601,321 which is incorporated herein by reference, includes an elongated outer frame 110 having a handle end 112 and a scoop end 114. Two scoops 124 and 126 are pivotally connected to the scoop end 114 of the outer frame 110 by means of outer nipples 774. The outer frame 110 includes an outer brace 118 extending from a first vertical side 144 to a second vertical side 146 for strengthening its scoop end 114 and for securing the lower end of two biasing springs 120 and 122 thereto.

Carried by the outer frame 110 and aligned therewith is an elongated inner control frame 132 having a handle end 136 and a scoop end 138. The inner frame 132 includes an inner brace 134 extending from a first inner vertical side 148 to a second inner vertical side 150 for strengthening the scoop end 138 and for securing the upper end of the two biasing springs 120 and 122.

A rectangular portion 133 is also preferably provided between the first inner vertical side 148 and the second inner vertical side 150 at the central portion of the inner control frame 132 for providing additional strength to the inner control frame 132.

Included at the scoop end 138 of the inner control frame 132 is a pair of linkage arms 140 and 141 for flexibly and pivotally connecting one side of each scoop 124 and 126 to one side of the inner control frame 132. A second pair of linkage arms 142 and 143 is provided for flexibly and pivotally connecting the other side of each scoop 124 and 126 to the other side of the inner control frame.

The inner control frame 132 can be moved upwardly against the force of biasing springs 120 and 122, until the handle end 136 of the inner control frame 132 meets a stop portion 116 of outer frame 112.

Preferably, the retrieval device, except for the biasing springs 120, 122 and portions of the latch mechanism of the storage compartment door 810, is made from a hard plastic material with the linkage arms 140, 141, 142, and 143 being at least slightly flexible. The device is therefore inexpensive to manufacture, yet strong so that is it not easily broken. Further, the plastic material can be easily cleaned.

The scoops 124 and 126 are formed to mate with each other so that they form a container having a closed bottom 354 and an open top 356. The scoops 124 and 126 are connected at central pivot points 258 that also connect both scoops 124 and 126 to the outer frame 110. When a user pulls inner control frame 132 upwardly toward the stop portion 116, the linkage arms 140, 141, 142 and 143 cause the scoops 124 and 126 to pivot in opposite directions, opening the bottom portion 354. When the user releases the inner control frame 132, the biasing springs 120 and 122 pull the outer frame 110 and the inner control frame 132 back to their original positions by means of the inner brace 134 and the outer brace 118.

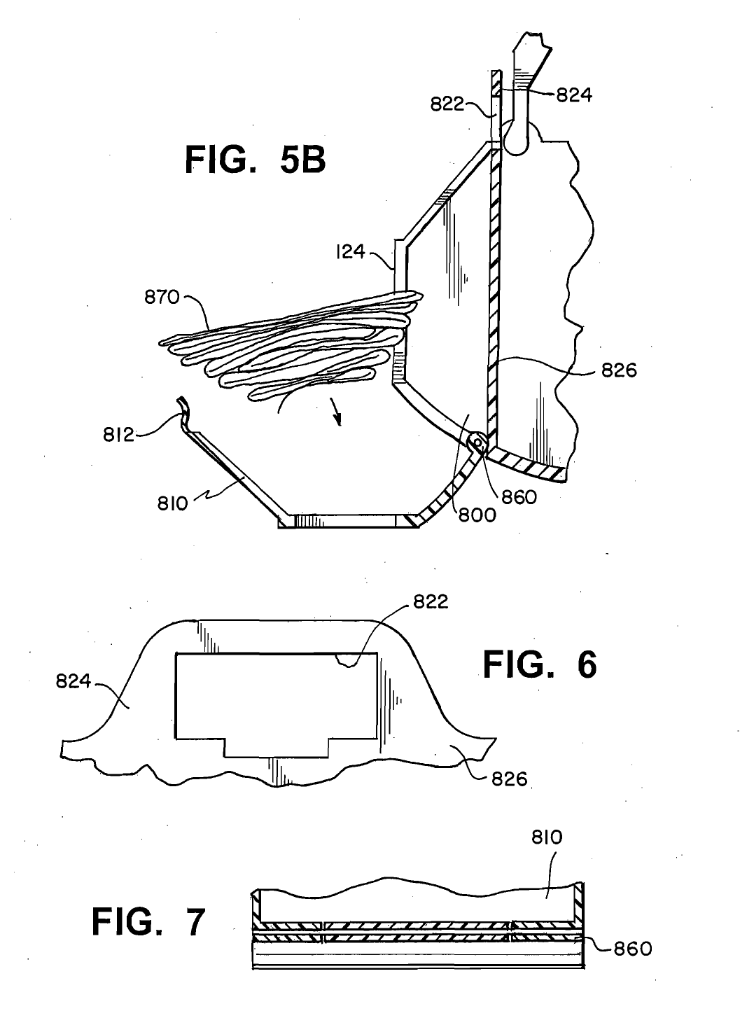

As shown in FIG. 5A, a storage compartment 800 is incorporated into scoop element 124. The storage compartment 800 is sized to receive and store various items, such as a plurality of plastic bags. The storage compartment 800 includes a cover 810 that is connected to scoop element 124. The cover 810 can be opened and closed to allow access to the storage compartment 800 and the contents therein. Preferably, the cover 810 is pivotally connected to the scoop element 124 so that the cover 810 does not detach from the scoop element 124, and can not be lost. The cover 810 can be pivoted into an open position so that various items such as plastic bags 870 can be placed into the storage compartment 800. Once the items are placed in the storage compartment 800, the cover 810 can be pivoted into the closed position in order to secure the contents 870 within the storage compartment 800. Alternatively, the cover 810 can be removably connected to the scoop element 124 so that the cover 810 engages the scoop element 124, and is connected to the scoop element 124 by the friction between the cover 810 and the scoop element 124, a mechanical snap or lock mechanism, or other means of mechanical affixation known in the art.

As depicted in FIGS. 5B and 7, a hinge mechanism 860 allows cover 810 to be pivoted between the open and closed positions. Hinge mechanism 860 may incorporate a hinge pin, or hinge pins may be formed integral with a plastic cover 810, or mechanism 860 may be any other suitable hinge design known to those skilled in the art permitting cover 810 to pivotally open and close. FIGS. 1 and 5A shows cover 810 in a closed position and FIG. 5B shows cover 810 in an open position.

Cover 810 is maintained in a closed position by a latching mechanism. The latching mechanism comprises a receiving element 824 and a mating element 812. The receiving element 824 is preferably integral with separating wall 826 as shown in FIGS. 5A and 5B, but may also be separately connected to separating wall 826. Receiving element 824 further includes an opening 822, the opening 822 being sized to receive mating element 812. As depicted in FIG. 5B, mating element 812 is formed as a protrusion on cover 810. Mating element 812 may also be separately attached to cover 810 and can be made from plastic or other suitable materials. The locations of the mating element 812 and the receiving element 824 could alternatively be switched such that the mating element is located on the separating wall and the receiving element is located on the cover.

Inserting the mating element 812 through the opening 822 of the receiving element 824 retains the cover 810 in a closed position. The mating element 812 can be manipulated by applying force, such as finger pressure, to the mating element 812 which will cause the element to flex such that mating element 812 can be passed through opening 822. When the mating element 812 is inserted through opening 822 and the force is removed, the mating element 812 returns to its original, unflexed position. In the unflexed position mating element 812 cannot pass through opening 822, thus cover 810 is maintained in a closed position. Additionally, the cover 810 may be retained in a closed position by other latching mechanisms including straps and snaps, Velcro, by an integral fastener type design or any other suitable means.

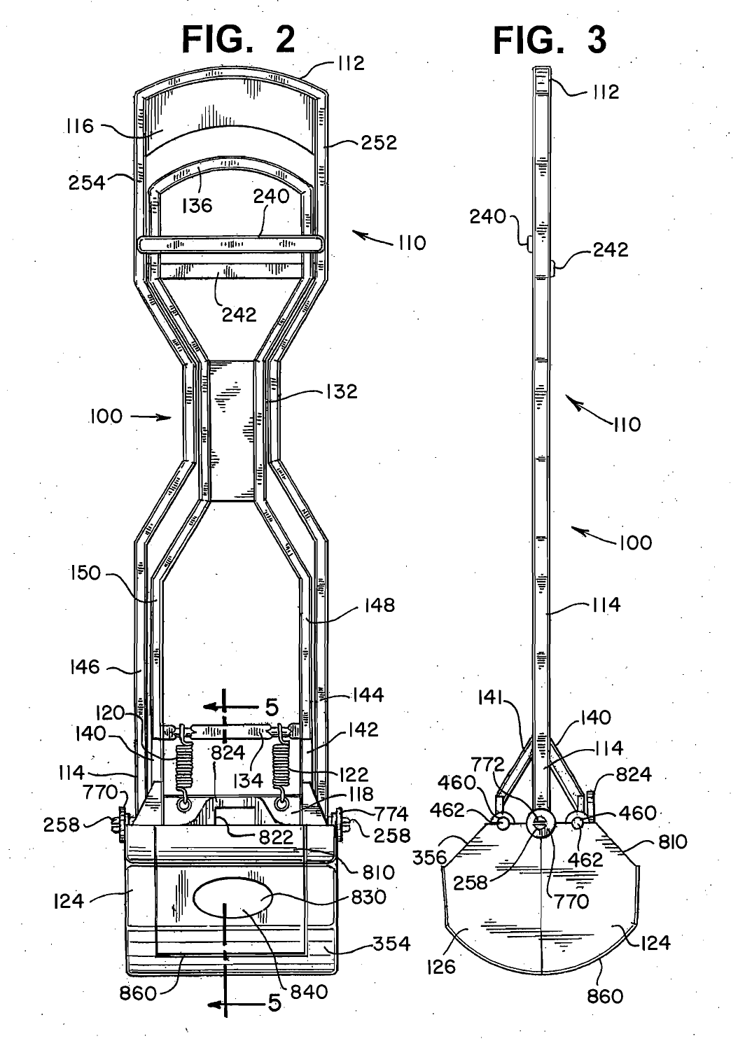

As depicted in FIGS. 1 and 2, cover 810 includes a hole 830. Hole 830 permits access to the plastic bags within storage compartment 800. Hole 830 allows a user to remove the contents of the storage compartment 800 while cover 810 is in the closed position. As shown in FIGS. 5A and 5B, a plurality of plastic bags 870 are stored in storage compartment 800 and the plastic bags can be removed individually from storage compartment 810 by pulling the plastic bag from the compartment through hole 830. Preferably the plastic bags 870 are folded and interleaved such that as a first bag is dispensed through the hole 830 a successive bag is partially disposed through the hole and is ready to be dispensed. The plastic bags may also be separably interconnected and provided in a folded stack or in a roll of bags. Hole 830 may also include a dispensing flap 840 which would further facilitate the contents (such as plastic bags) of the compartment 800 to be dispensed individually. The dispensing flap may be a flexible plastic piece disposed within the hole having two intersecting slits, the plastic bags being dispensed through the slits. FIG. 1 depicts an exemplary plastic bag 850 that may be dispensed from the compartment 800.

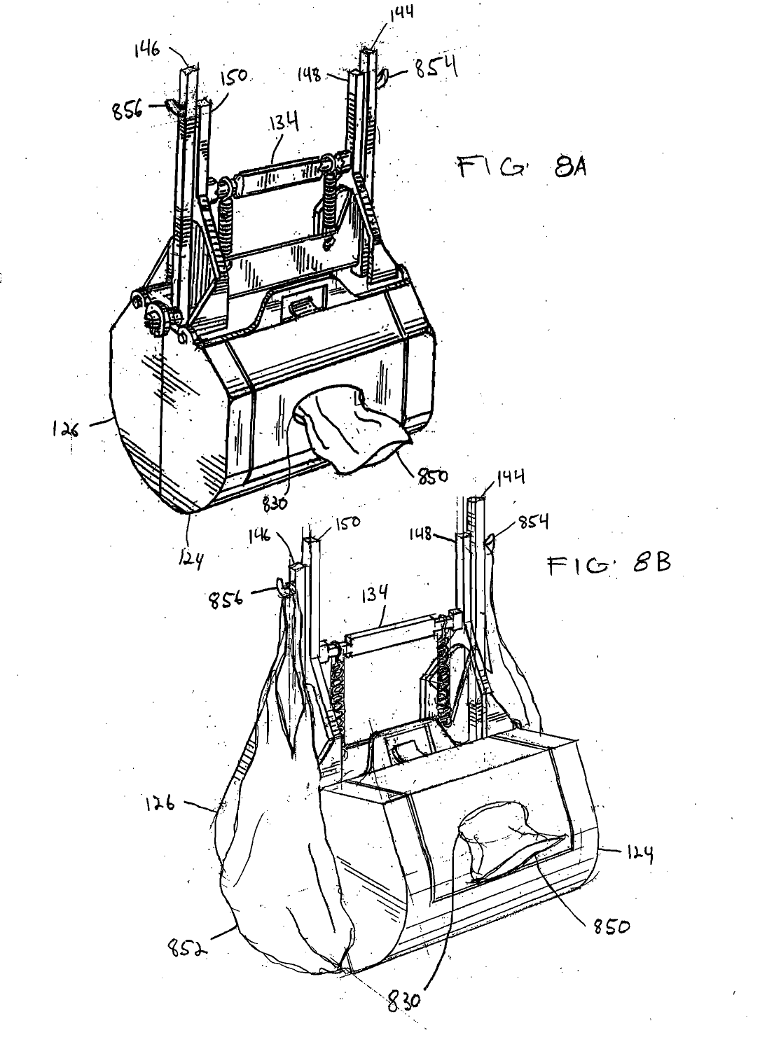

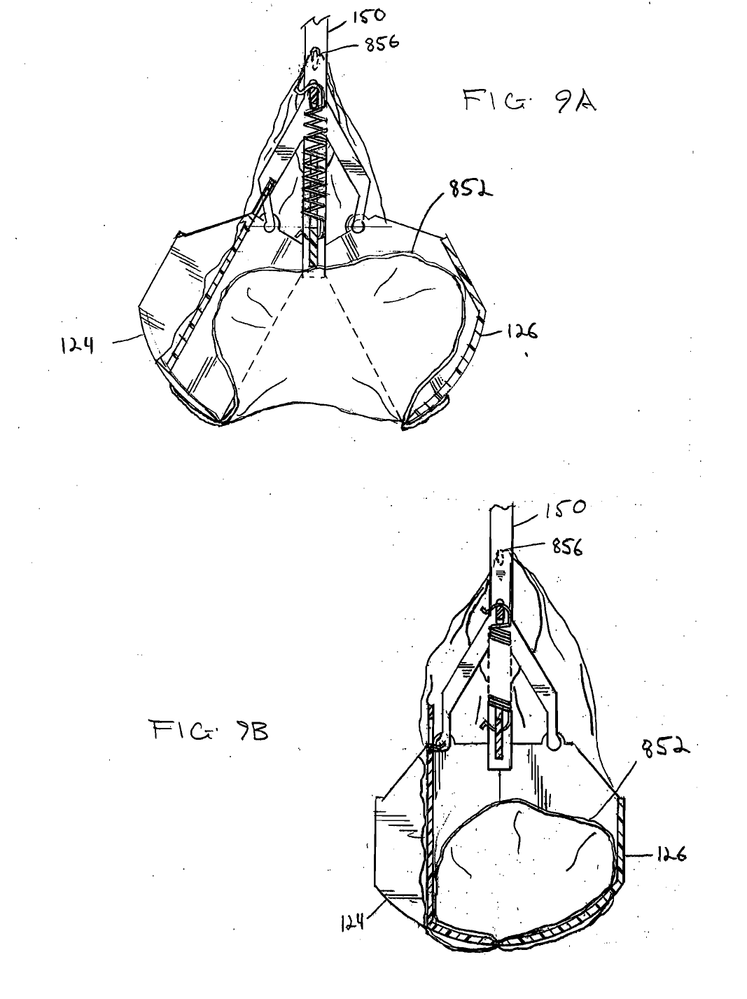

As shown in FIGS. 8A-9B, the first vertical side 144 and the second vertical side 146 of the outer frame 110 may include a pair of hooks 854 and 856, respectively. The upper portion of the plastic bags are provided with holes or slits that are placed over the hooks 854 and 856. The plastic bag may have handles with handle holes, which could be placed over the hooks 854, 856. FIG. 8B shows bag 852, which is one of the plurality of bags 870, placed over the scoops 124, 126 and held in place by the hooks, 854, 856. The hooks help maintain the bag in position as the refuse is being retrieved. As shown in FIGS. 9A and 9B, once the bag 852 is held by the hooks, the lower closed end portion of bag 852 can be inserted into the interior cavity formed by the scoops 124 and 126. The plastic bag 852 provides a protective barrier around the scoops 124, 126. With the bag 852 placed over the exterior of the scoops and inserted into the interior of the scoops, as shown in FIG. 9A, the refuse can be retrieved directly into the bag 852 without getting the scoops 124, 126 soiled.

In operation, the user squeezes the inner control frame 132 in the manner described above. This results in scoops 124 and 126 pivoting upwardly and outwardly creating an open portion between the two scoops located at the lower end of the device. The user then places the now open portion over the refuse to be picked up. The release of the inner control frame 132 allows the scoops 124 and 126 to close, scooping up the refuse in the process. The structure and operation of the device is fully described in U.S. Pat. No. 5,601,321. The user may next utilize a plastic bag 850 stored in a storage compartment 800 to dispose of the refuse.

Alternatively, the user first removes a plastic bag 852 from the storage compartment and places the handle holes over the hooks 854, 856 to hold the bag in place. The scoops 124, 126 are opened and the lower closed end portion of the plastic bag 852 is inserted into the interior area of the scoops 124, 126. The open scoops with plastic bag disposed within is now placed over the refuse and then scoops are closed. The refuse is retrieved within the lower closed end portion of the bag, which is within the interior of scoops. The plastic bag handles are removed from the hooks, the refuse retrieval device is inverted, the scoops are opened, and then the bag with the refuse is removed. Thus, refuse can be retrieved into the bag 852 without soiling the refuse retrieval device.

FIG. 2 illustrates the front elevation view of the preferred embodiment of the present invention. The outer frame 110 is in the form of a flat hour-glass like shape with the inner control frame 132 being similarly shaped but sized to fit within the outer frame 110.

The inner control frame 132 maintains its alignment within the outer frame 110 by means of first and second alignment members 240 and 242. These alignment braces extend between both sides of the outer frame 110. As shown, the first alignment member 240 is attached to the front of two top vertical members 252 and 254 of the outer frame 110, while the second alignment member is similarly attached to the rear.

FIG. 2 also shows the cover 810 to the storage compartment 800, the hole 830, the opening 822 in the receiving element 824 of the latching mechanism, and dispensing flap 840.

FIG. 3 is a right side view of the preferred embodiment of the present invention further illustrating certain features of the invention. As described above, the linkage arms 140, 141, 142 and 143 provide connectivity between the inner control frame 132 and the scoops 124 and 126. The linkage arms outwardly and downwardly extend at an acute angle for a distance from the inner control frame 132, in opposite directions and are preferably integral with the inner control frame 132. The linkage arms then extend vertically for a short distance so that each linkage arm 140, 141, 142 and 143 can be pivotally connected to a scoop, linkage arms 140 and 142 being connected to the left and right sides of scoop 124 respectively, and linkage arms 141 and 143 being connected to the left and right sides of scoop 126 respectively.

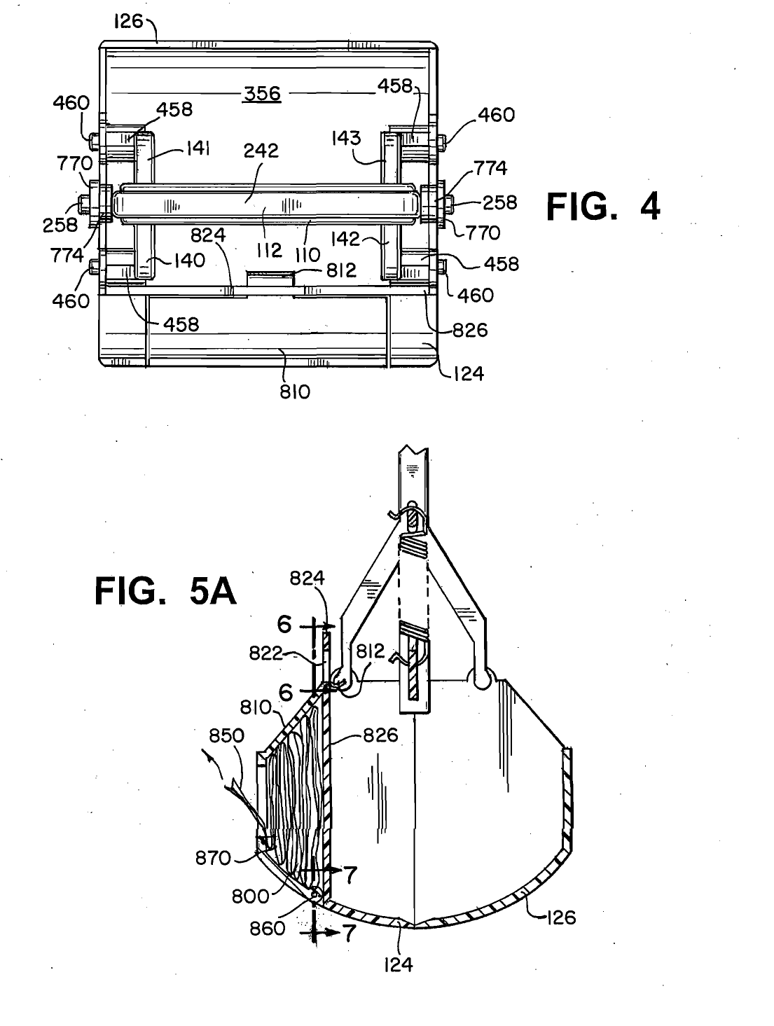

FIG. 4 shows the top view of the present invention in a closed position. As illustrated, the top portion 356 of the container formed by the mating of the two scoops 124 and 126 is open. Also, the connection between the linkage arms 140-143 to the scoops 124 and 126 is illustrated. Each of the linkage arms 140-143 includes a cylindrical portion 458 having a nipple 460 extending therefrom with the cylindrical portion 458 and nipple 460 extending towards the side of a scoop 124 or 126. Each of the scoops 124 and 126 include a right and left receiving hole 462 and 464, positioned adjacent to the central pivot point 258, dimensioned to receive a nipple 460 as shown in FIG. 3. The nipples 460 inserted in their respective receiving holes 462 provide the pivotability of the scoops 124 and 126 on the linkage arms 140-143.

Referring now to FIGS. 2, 3, and 5A, the two scoops 124 and 126 mate so as to form a container. The scoops 124 and 126 are tightly mated in the closed position as a result of the biasing springs 120 and 122. The biasing springs 120 and 122 bias the inner control frame 132 in a down or closed position by pulling the inner brace 134 toward the outer brace 118. In this position, the linkage arms 140-143 push down on the cylindrical portions 458 thus keeping them in alignment with pivot points 258 and tightly mating the scoops 124 and 126. As is evident, the container formed by scoops 124 and 126 in the closed position has a rounded bottom portion 354.

As shown in FIG. 5A, the storage compartment 800 is incorporated into scoop element 124. A storage compartment 800 may be incorporated into either scoop element 124 or 126, or both. The volume of storage compartment 800 is defined by scoop element 124, cover 810 and separating wall 826. Separating wall 826 may be formed integrally with scoop element 124. Additionally, separating wall 826 can comprise a separate member made of various materials, such as metal or plastic. The separating wall could then be attached to scoop element 124 using various means including adhesive or plastic welding techniques.

Separating wall 826 provides a barrier between the storage compartment 800, where items such as plastic bags can be stored, and the refuse collecting container portion formed by scoop elements 124 and 126. The separating wall 826 divides the interior of scoop element 124 into an inner portion and an outer portion, as depicted in FIG. 5B. Storage compartment 800 is located in the outer portion of scoop element 124. The inner portion of the interior of scoop 124 and the interior of scoop 126 remain available for collecting refuse. Thus, the storage compartment can be located on the interior of the scoop element and provide storage for plastic bags and the scoop can also function to pick up refuse while keeping the items in the storage compartment separate from the refuse. Additionally, by locating the storage compartment in the scoop element, the overall shape, design and aesthetics of the scooper device are preserved.

FIG. 5A illustrates the cover 810 in a closed position with the mating element 812 inserted into the opening 822 of the receiving element 824 of the latch mechanism. FIG. 5A also shows an illustrative plastic bag 850, the hinging mechanism 860 that facilitates the pivoting open and close of cover 810, and the storage of a plurality of plastic bags 870.

FIG. 5B is an enlarged close-up view of storage compartment 800 with cover 810 in an open position. The separating wall 826 is also visible. FIG. 5B also shows opening 822 of the receiving element 824, mating element 812, hinging mechanism 860, and the plurality of plastic bags 870 that are contained in the storage compartment 800.

FIG. 6 is an enlarged close-up view of the receiving element 824 of the latch mechanism. The latch mechanism is designed to hold the cover 810 of the storage compartment 800 in a closed position and is accomplished by inserting mating element 812 on the cover 810 through opening 822 located in receiving element 824.

FIG. 7 is an enlarged close-up view of the hinging mechanism 860. The hinge mechanism 860 allows the cover 810 to open and close.

While the present invention has been particularly shown and described with reference to preferred embodiments thereof, it will be understood by those skilled in the art that various changes in form from the spirit and scope of the invention.

What is claimed is:

1. A refuse retrieval device comprising:
two scoop elements that can be pivotally opened and closed for retrieving refuse; and
a storage compartment incorporated in one of the scoop elements for storing plastic bags, the storage compartment having an interior wall disposed within the interior of the one scoop element, and an exterior wall, wherein at least a portion of the exterior wall comprises at least a portion of the one scoop element;
wherein the plastic bags are accessible from the exterior of the scoop elements so that a plastic bag can be removed from the storage compartment and used to dispose of retrieved refuse.

2. The refuse retrieval device of claim 1, wherein the one scoop element includes a cover that can be opened to provide access to the storage compartment.

3. The refuse retrieval device of claim 2, wherein the cover includes a hole through which the plastic bags may be removed from the storage compartment.

4. The refuse retrieval device of claim 3, wherein the cover includes a dispensing flap supported by the cover and positioned relative to the hole such that the dispensing flap inhibits the removal of more than one plastic bag at a time.

5. The refuse retrieval device of claim 1, further comprising:
a cover removably connected to the one scoop element, the cover capable of being removed from the one scoop element in order to provide access to the storage compartment so that plastic bags may be placed therein.

6. The refuse retrieval device of claim 1, further comprising:
a cover pivotally connected to the one scoop element, the cover capable of being selectively pivoted into an open position in order to provide access to the storage compartment so that plastic bags may be placed therein, and a closed position wherein the plastic bags disposed within the storage compartment are secured.

7. The refuse retrieval device of claim 1, further comprising:
a hook connected to the refuse retrieval device for supporting one of the plastic bags after it has been removed from the storage compartment, wherein the plastic bags include a hole through which the hook is inserted.
